(19) United States
(12) Patent Application Publication
(10) Pub. No.: US 2024/0316970 A1
(43) Pub. Date: Sep. 26, 2024

(54) THERMAL PRINTER

(71) Applicant: Seiko Instruments Inc., Chiba-shi (JP)

(72) Inventor: Toshihiro HIRAMA, Chiba-shi (JP)

(21) Appl. No.: 18/608,324

(22) Filed: Mar. 18, 2024

(30) Foreign Application Priority Data
Mar. 22, 2023 (JP) 2023-044854

(51) Int. Cl. B41J 29/13; B41J 11/04

(52) U.S. Cl. CPC B41J 29/13; B41J 11/04

(57) ABSTRACT

A thermal printer includes: a housing; a printing unit, which includes a head unit and a platen unit including a platen roller, and is received in the housing; a cover configured to be capable of opening and closing the housing; an open button of the cover; and a guide shaped portion, which is provided below a gap between the open button and the housing and at a position corresponding to the gap, and extends along an up-and-down direction in a horizontal posture that is a state of the thermal printer placed such that a sheet delivery port defined between the cover and the housing is facing upward.

### RELATED APPLICATIONS

This application claims priority to Japanese Patent application No. JP2023-044854, filed on Mar. 22, 2023, the entire content of which is incorporated herein by reference.

### BACKGROUND OF THE INVENTION

### 1. Field of the Invention

The present invention relates to a thermal printer.

### 2. Description of the Related Art

Hitherto, there has been known a thermal printer as a printer that performs printing on a recording sheet (heat-sensitive sheet). For such a thermal printer, various technologies have been proposed to prevent an inside of the printer from being immersed in water by liquid such as rainwater during outdoor work or water on user's hands.

As an example of this type of technology, there is known a configuration of a thermal printer including a retaining portion that retains liquid having entered a housing in a carriage posture, which is a posture during carriage, and a flow path that guides the liquid having entered the housing to the retaining portion (see Japanese Patent Application Laid-open No. 2017-87534). According to this related art, with the retaining portion, water immersion inside the housing can be prevented without increasing a size of a drain hole for draining the liquid.

However, in the above-mentioned related art, in a posture different from the carriage posture, for example, in a horizontal posture that is a state of the printer placed on a floor such that a delivery port for a sheet is facing upward, when the printer is splashed with liquid such as water, there has been a fear in that water immersion cannot be prevented effectively.

One of objects of the present disclosure is to provide a thermal printer capable of effectively preventing water immersion in a housing.

### SUMMARY OF THE INVENTION

According to one embodiment of the present invention, there is provided a thermal printer, the thermal printer including: a housing; a printing unit, which includes a head unit and a platen unit including a platen roller, and is received in the housing; a cover configured to be capable of opening and closing the housing; an open button of the cover; and a guide shaped portion, which is provided below a gap between the open button and the housing and at a position corresponding to the gap, and extends along an up-and-down direction in a horizontal posture that is a state of the thermal printer placed such that a sheet delivery port defined between the cover and the housing is facing upward.

In the above-mentioned thermal printer according to the one embodiment of the present invention, wherein the guide shaped portion is provided between the housing and an opposed component received inside the housing.

In the above-mentioned thermal printer according to the one embodiment of the present invention, wherein the guide shaped portion extends downward beyond the opposed component.

In the above-mentioned thermal printer according to the one embodiment of the present invention, the thermal printer further includes a substrate provided below the opposed component, wherein the substrate is arranged closer to a center of an inside of the housing than the opposed component when seen from the up-and-down direction, and wherein the guide shaped portion is provided at such a position as to be prevented from overlapping the substrate when seen from the up-and-down direction.

In the above-mentioned thermal printer according to the one embodiment of the present invention, wherein the open button includes a downward protruding portion that protrudes downward, and wherein the guide shaped portion is provided at a position corresponding to the downward protruding portion.

In the above-mentioned thermal printer according to the one embodiment of the present invention, wherein the guide shaped portion is a rib formed on an inner wall of the housing.

In the above-mentioned thermal printer according to the one embodiment of the present invention, the thermal printer further includes a retaining portion, which is formed in a bottom surface of the housing, and is configured to retain liquid guided by the guide shaped portion.

### BRIEF DESCRIPTION OF THE DRAWINGS

FIG. 1 is a perspective view for illustrating a state in which a thermal printer according to a first embodiment takes a horizontal posture.

FIG. 2 is a perspective view for illustrating a state in which a paper cover of the thermal printer according to the first embodiment is opened.

FIG. 3 is a perspective view of an open button.

FIG. 4 is a sectional view taken along the line IV-IV of FIG. 1.

FIG. 5 is a perspective view of an inside of a casing of the thermal printer according to the first embodiment when seen from a lower side thereof.

FIG. 6 is an enlarged view of a portion VI of FIG. 5.

FIG. 7 is a perspective view of an inside of a casing of a thermal printer according to a second embodiment when seen from a lower side thereof.

### DETAILED DESCRIPTION OF THE PREFERRED EMBODIMENTS

Now, embodiments of the present invention are described with reference to the drawings. In the following description, components having the same or similar functions are denoted by the same reference symbols. Overlapping description of those components is omitted in some cases. In the drawings, FR, LH, and UP represent a front side, a left side, and an upper side of the thermal printer, respectively.

### First Embodiment

### (Thermal Printer)

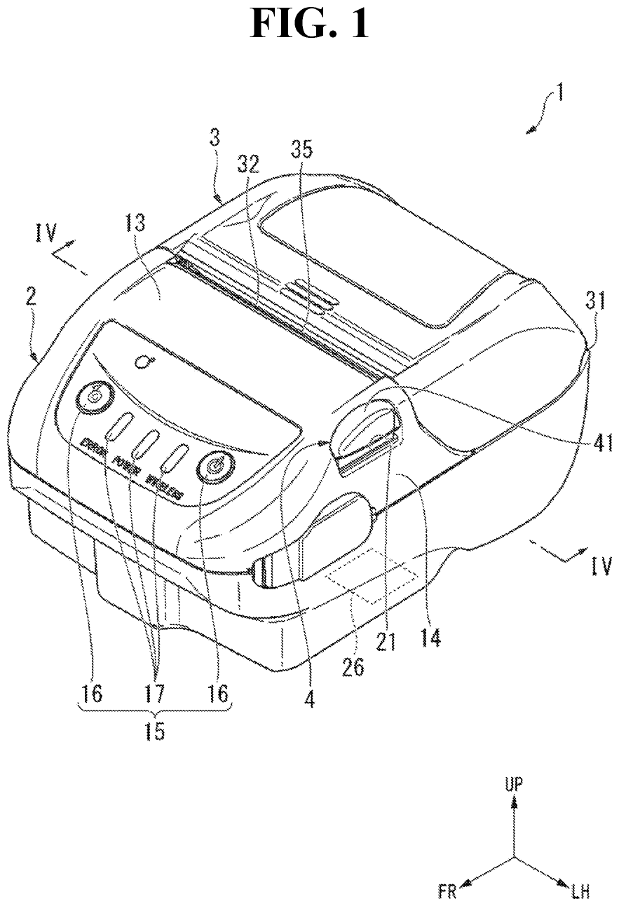

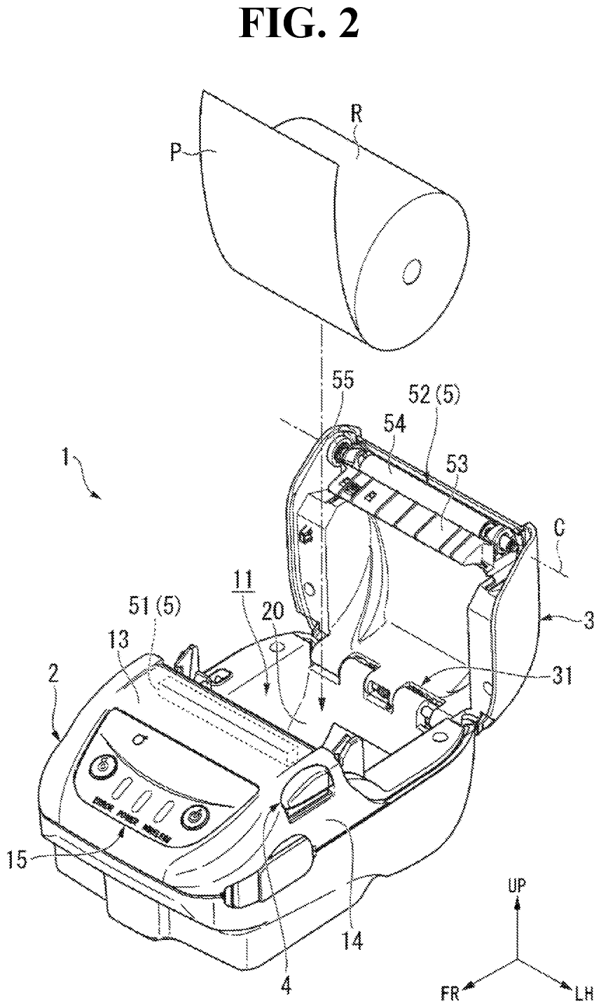

FIG. 1 is a perspective view for illustrating a state in which a thermal printer 1 takes a horizontal posture. FIG. 2 is a perspective view for illustrating a state in which a paper cover 3 of the thermal printer 1 is opened.

The thermal printer 1 according to this embodiment is used in a plurality of postures in some cases such as a use case of being placed on, for example, a desk or a floor and a use case of being carried by a user. In this embodiment, a state in which the thermal printer 1 is placed on, for example, a desk or a floor such that a delivery port 32 for a sheet is facing upward as illustrated in FIG. 1 is referred to as a horizontal posture that is assumed as a horizontally-placed posture. The thermal printer 1 taking the horizontal posture is described. When the thermal printer 1 is carried by a user in use, the thermal printer is used in such a posture that, for example, a front side in FIG. 1 is facing upward.

### (Casing)

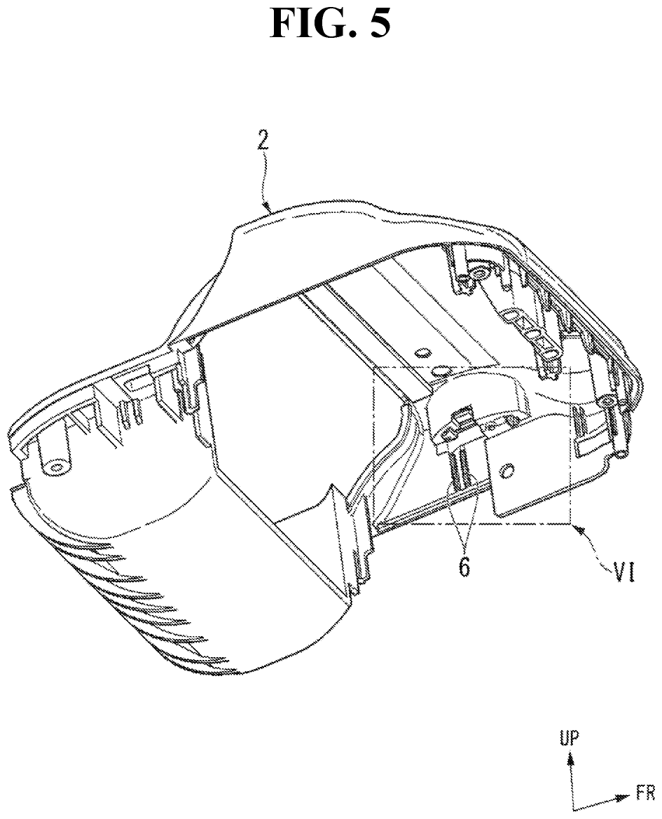

As illustrated in FIG. 1 and FIG. 2, the thermal printer 1 includes a casing 2 being a housing, the paper cover 3 (cover in claims), an open button 4, a printing unit 5, and guide shaped portions 6 (see FIG. 5). The casing 2 is made of a resin material such as polycarbonate or a metal material. A front portion of the casing 2 is formed into a rectangular parallelepiped shape having an upper wall 13. Meanwhile, a rear portion of the casing 2 is formed into a box shape having an opening portion 11 opened upward. An operation unit 15 that performs a variety of operations of the thermal printer 1 is arranged in the front portion of the upper wall 13 of the casing 2. The operation unit 15 is provided with a variety of function switches 16, such as a power switch and a FEED switch; and a variety of lamps 17, such as a POWER lamp and an ERROR lamp, the POWER lamp being arranged adjacent to the function switch 16 and notifying ON and OFF information on the power switch, the ERROR lamp notifying, for example, an error of the thermal printer 1. The open button 4 for opening the paper cover 3 is provided between the upper wall 13 and a side wall 14 of the casing 2.

As illustrated in FIG. 2, a roll sheet receiving portion 20 into which a roll sheet R is to be received through the opening portion 11 is formed in the rear portion of the casing 2. The roll sheet receiving portion 20 holds the roll sheet R. The roll sheet R is surrounded with the roll sheet receiving portion 20 and an inner surface of the paper cover 3, and thus the roll sheet R is held. The roll sheet receiving portion 20 has an arc-shaped lower surface in cross section when seen from a right-and-left direction. Under a state in which an outer peripheral surface of the roll sheet R is held in contact with an inner peripheral surface of the roll sheet receiving portion 20, the roll sheet receiving portion 20 holds the roll sheet R, and guides a recording sheet P, which is drawn out from the roll sheet R, to the printing unit 5. The recording sheet P to be used in this embodiment is a heat-sensitive sheet, and is suitably used for, for example, printing a variety of labels, receipts, and tickets. The recording sheet P is wound into a roll shape to form the roll sheet R having a through hole. The printing unit 5 performs printing on a region of the recording sheet P, which is drawn out from the roll sheet R.

As illustrated in FIG. 1, a retaining portion 26 is formed in a bottom of the casing 2, and is configured to retain liquid guided by the guide shaped portions 6 to be described later. The retaining portion 26 can retain a predetermined amount of the liquid having flowed into the bottom of the casing 2 when the thermal printer 1 takes the horizontal posture. The retaining portion 26 is, for example, a recessed portion formed in the bottom of the casing 2. The retaining portion 26 communicates with a drain hole (not shown) formed in the rear portion of the casing 2 (in the vicinity of a hinge structure 31 of the paper cover 3 to be described later). When the thermal printer 1 takes a carriage posture that corresponds to a state of the thermal printer 1 in which the hinge structure 31 is located below, the liquid retained in the retaining portion 26 is drained out of the casing 2 through the drain hole.

### (Paper Cover)

The paper cover 3 is a cover that opens and closes the opening portion 11 of the casing 2. The paper cover 3 is made of a resin material such as polycarbonate. As illustrated in FIG. 2, the hinge structure 31 is provided on a rear side of the paper cover 3, and pivotally supports the paper cover 3. The hinge structure 31 allows the paper cover 3 to be pivotable with respect to the casing 2. A front end (upper end in an opened state illustrated in FIG. 2) of the paper cover 3 is lockable to the casing 2 through intermediation of a platen unit 52 to be described later. When the open button 4 is pressed, locking between the casing 2 and the paper cover 3 is released, and the paper cover 3 is pivoted from a closing position illustrated in FIG. 1 to an opening position illustrated in FIG. 2. At the closing position of the paper cover 3 illustrated in FIG. 1, a gap defined between an upper edge of the paper cover 3 and a rear edge of the upper wall 13 of the casing 2 forms the delivery port 32 (sheet delivery port in claims) from which the recording sheet P printed by the printing unit 5 is to be delivered.

Cutting blades 35 that cut the recording sheet P delivered from the delivery port 32 are provided at an opening edge of the delivery port 32. The cutting blades 35 are respectively formed integrally with the rear edge (portion of the opening edge, which is located on the front side) of the upper wall 13 of the casing 2; and a front edge of the paper cover 3. The recording sheet P delivered from the delivery port 32 is pulled down toward the cutting blades 35, and thus the recording sheet P is cut.

A strap, a hook, or the like may be mountable to a lower surface or the front portion of the casing 2. For example, when a user carries the thermal printer 1, the user can hang the strap around a neck or a shoulder, or mount the hook to a waist belt to carry and use the thermal printer 1.

### (Open Button)

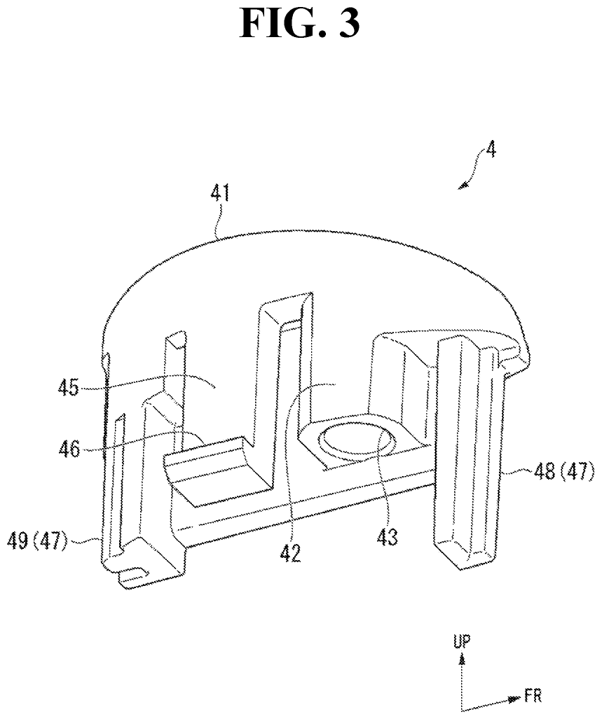

FIG. 3 is a perspective view of the open button 4 when seen from a lower right side thereof. As illustrated in FIG. 1 and FIG. 3, the open button 4 is provided between the upper wall 13 and the side wall 14 (left side wall 14 in this embodiment) of the casing 2. The open button 4 is a button for opening the paper cover 3, and can open the paper cover 3 when the open button 4 is pressed downward.

As illustrated in FIG. 3, the open button 4 includes a main body portion 41, a positioning portion 42, a locking portion 45, and a downward protruding portion 47. Under a state in which the open button 4 is mounted to the casing 2, at least parts of the positioning portion 42, the locking portion 45, and the downward protruding portion 47 are received in a button receiving portion 21 formed in the casing 2. The main body portion 41 is a portion to be pressed by a user. Under a state in which the open button 4 is received in the button receiving portion 21 formed in the casing 2, the main body portion 41 is exposed to the outside. An upper surface of the main body portion 41 is formed into a gentle arc shape that protrudes upward when seen from the right-and-left direction.

The positioning portion 42 is formed more on a back side (right side in this embodiment) in the right-and-left direction than the main body portion 41. The positioning portion 42 is connected to the main body portion 41. The positioning portion 42 is formed into a tubular shape in which a pin insertion hole 43 extending along an up-and-down direction is formed in an inside of the positioning portion 42. A pin (not shown) formed integrally with the casing 2 is inserted into the pin insertion hole 43. Thus, the open button 4 is restrained from moving with respect to the casing 2 in a front-and-rear direction and the right-and-left direction, and is mounted so as to be movable with respect to the casing 2 only in the up-and-down direction. Further, the open button 4 is always urged upward to the casing 2 by an urging member (such as a spring) (not shown).

The locking portion 45 is formed more on the back side (right side in this embodiment) in the right-and-left direction than the main body portion 41 and more on the rear side than the positioning portion 42. The locking portion 45 extends along the up-and-down direction, and is formed into a plate shape with its thickness direction corresponding to the right-and-left direction. An upper end portion of the locking portion 45 is connected to the main body portion 41. A claw portion 46 to be engaged with the casing 2 is formed at a lower end portion of the locking portion 45. Accordingly, when the open button 4 is inserted into the button receiving portion 21 of the casing 2 from above, a plate-shaped portion of the locking portion 45 is elastically deformed in the right-and-left direction, and the claw portion 46 climbs over a locked portion (not shown) of the casing 2 so as to be engaged with the casing 2. Thus, the open button 4 is restrained from slipping out of the casing 2 upward. In this manner, the open button 4 is mounted to the casing 2.

The downward protruding portion 47 is formed more on the back side (right side in this embodiment) in the right-and-left direction than the main body portion 41. The downward protruding portion 47 is connected to the main body portion 41. The downward protruding portion 47 extends along the up-and-down direction. The downward protruding portion 47 has a larger downward protruding amount than those of the positioning portion 42 and the locking portion 45. In this embodiment, as the downward protruding portion 47, a first downward protruding portion 48 and a second downward protruding portion 49, that is, two protruding portions in total are provided.

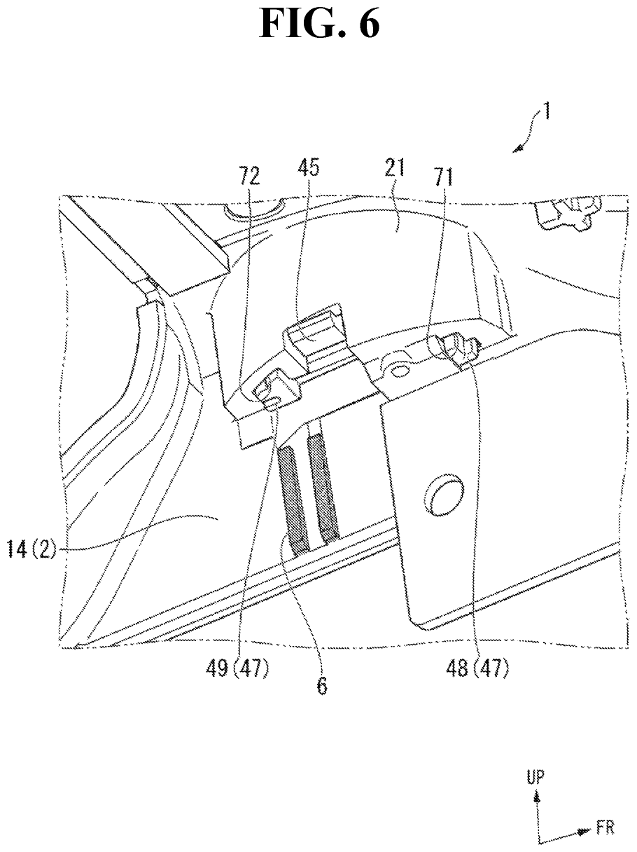

The first downward protruding portion 48 is formed more on the front side in the front-and-rear direction than the positioning portion 42. The first downward protruding portion 48 is inserted into an insertion portion 71 formed in the casing 2, thereby protruding to the inside of the casing 2 (see FIG. 6). The first downward protruding portion 48 has an L shape in cross section when seen from a direction orthogonal to a longitudinal direction. The second downward protruding portion 49 is formed more on the rear side in the front-and-rear direction than the locking portion 45. The second downward protruding portion 49 is inserted into an insertion portion 72 formed in the casing 2, thereby protruding to the inside of the casing 2 (see FIG. 6). The second downward protruding portion 49 has a U shape opened rearward in cross section when seen from the direction orthogonal to the longitudinal direction.

### (Printing Unit)

As illustrated in FIG. 2, the printing unit 5 is received in the casing 2. The printing unit 5 includes a head unit 51 provided at a rear end portion of the upper wall 13 of the casing 2; and the platen unit 52 provided at a front end portion (upper end portion in the opened state illustrated in FIG. 2) of the paper cover 3. The platen unit 52 is detachably combined with the head unit 51 in accordance with opening and closing operation of the paper cover 3. The platen unit 52 includes a platen frame 53 mounted to the paper cover 3; and a platen roller 54 supported on the platen frame 53 so as to be rotatable.

The platen roller 54 is supported on the platen frame 53 so as to be rotatable with an axis C extending along the right-and-left direction being a rotation center. A platen gear 55 is provided at a right end portion of the platen roller 54. Further, the head unit 51 includes a gear train mechanism (not shown) to be combined with the platen gear 55, and a motor connected to the gear train mechanism. When the platen unit 52 and the head unit 51 are combined with each other, the platen gear 55 meshes with the gear train mechanism provided on the head unit 51 side, and thus transmits a rotational driving force of the motor to the platen roller 54. Further, when the platen unit 52 and the head unit 51 are combined with each other, a thermal head in the head unit 51 is brought into press-contact with an outer peripheral surface of the platen roller 54.

### (Guide Shaped Portions)

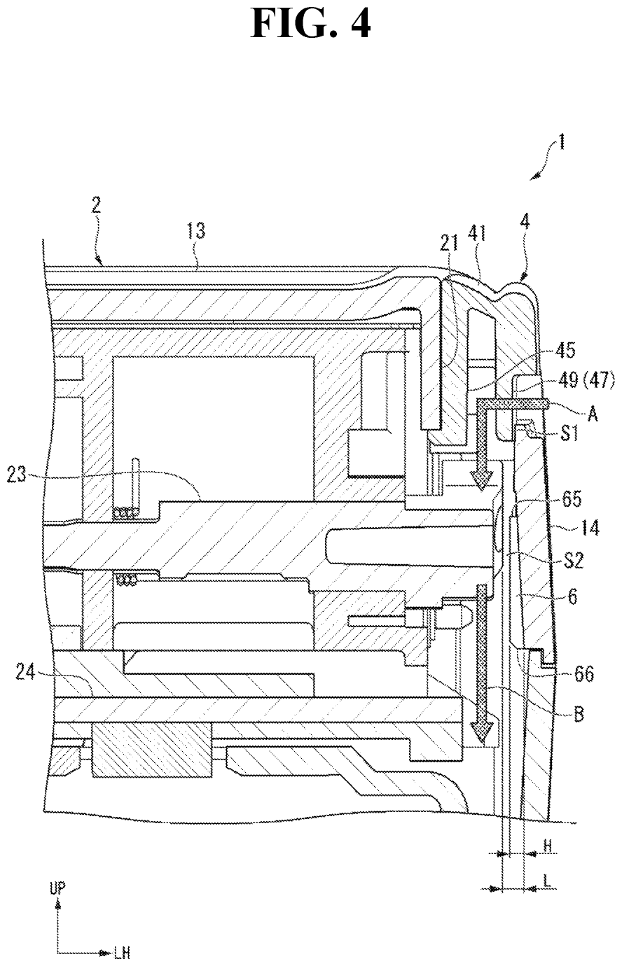

FIG. 4 is a sectional view taken along the line IV-IV of FIG. 1. FIG. 5 is a perspective view of an inside of the casing 2 in the thermal printer 1 according to the first embodiment when seen from the lower side thereof. FIG. 6 is an enlarged view of a portion VI of FIG. 5. As illustrated in FIG. 4 to FIG. 6, in the horizontal posture of the thermal printer 1, each of the guide shaped portions 6 is provided below a gap S1 between the open button 4 and the casing 2 and at a position corresponding to the gap S1. Each of the guide shaped portions 6 is formed so as to have a constituent extending at least along the up-and-down direction.

Specifically, in this embodiment, the guide shaped portions 6 are ribs extending along the up-and-down direction. As illustrated in FIG. 6, a pair of the guide shaped portions 6 (ribs) are provided so as to be spaced apart from each other in the front-and-rear direction. The two ribs have the same shape. The guide shaped portions 6 are formed integrally with an inner wall of the housing. As illustrated in FIG. 4, each of the guide shaped portions 6 is provided at the position corresponding to the gap S1 between the open button 4 and the casing 2 in the front-and-rear direction and the right-and-left direction. In other words, when seen from the up-and-down direction, the guide shaped portions 6 and the gap S1 between the open button 4 and the casing 2 overlap each other. More specifically, as illustrated in FIG. 6, each of the guide shaped portions 6 is provided at a position corresponding to the second downward protruding portion 49 in the front-and-rear direction and the right-and-left direction. The guide shaped portions 6 are provided directly below the second downward protruding portion 49.

As illustrated in FIG. 4, inside the casing 2, a release lever 23 (opposed component in claims) is received below the open button 4. The release lever 23 is arranged inside the casing 2 at a distance L from an inner wall of the casing 2. The distance L is, for example, several millimeters. The guide shaped portions 6 are provided between the casing 2 and the release lever 23 that are separated from each other by the distance L. A height H of each of the guide shaped portions 6 along the right-and-left direction is smaller than the separation distance L between the casing 2 and the release lever 23 (H<L).

In this embodiment, the guide shaped portions 6 extend downward beyond the release lever 23 in the up-and-down direction. Specifically, an upper end portion 65 of each of the guide shaped portions 6 is located at substantially the same height as that of an upper surface of the release lever 23 in the up-and-down direction. A lower end portion 66 of each of the guide shaped portions 6 is located below a lower end portion of the release lever 23 in the up-and-down direction. The upper end portion 65 of each of the guide shaped portions 6 may be located above the upper surface of the release lever 23.

A substrate 24 is provided inside the casing 2 below the release lever 23. The substrate 24 is, for example, an electronic substrate that energizes the printing unit 5, the operation unit 15, or other units. As illustrated in FIG. 4, the substrate 24 is arranged closer to a center of the inside of the casing 2 in the right-and-left direction than the release lever 23. Each of the guide shaped portions 6 is provided at such a position as to be prevented from overlapping the substrate 24 when seen from the up-and-down direction. In other words, each of the guide shaped portions 6 is provided more on an outer side (inner wall side of the casing 2) in the right-and-left direction than an outer end portion of the substrate 24.

With the guide shaped portions 6, for example, when the liquid such as water (hereinafter, sometimes simply referred to as “liquid”) enters the casing 2 through the gap S1 between the casing 2 and the open button 4 in the horizontal posture, the liquid flows in the process described below. That is, first, when the thermal printer 1 taking the horizontal posture is splashed with the liquid, part of the liquid sometimes enters the casing 2 through the gap S1 between the casing 2 and the open button 4. The liquid having entered the casing 2 through the gap S1 flows downward along the downward protruding portion 47 (second protruding portion in FIG. 3 and FIG. 6) of the open button 4 (see the arrow A of FIG. 4). The liquid having reached a lower end of the downward protruding portion 47 drops downward due to its own weight. At this time, with the guide shaped portions 6 provided directly below the downward protruding portion 47, momentum of the liquid is reduced when the dropping liquid comes into contact with the guide shaped portions 6. Further, the release lever 23 and the inner wall of the casing 2 define a narrower gap S2, and hence the liquid is guided downward along the narrow gap S2 and the guide shaped portions 6.

The liquid having reached lower ends of the guide shaped portions 6 drops downward due to its own weight, or drops downward along the inner wall of the casing 2. At this time, due to an inertial force and own weight applied to the liquid, the liquid drops along substantially the same direction as a direction in which the liquid has flowed along the guide shaped portions 6, that is, drops along the up-and-down direction. Further, the momentum of the liquid is reduced by the guide shaped portions 6, and hence the liquid is guided toward the bottom of the casing 2 without spattering to the substrate 24 side (see the arrow B of FIG. 4). Then, the liquid is guided to the retaining portion 26. When the posture of the thermal printer 1 is changed from the horizontal posture to the carriage posture, the liquid retained in the retaining portion 26 flows into the drain hole (not shown) and is drained out of the casing 2 from the drain hole. In this manner, the liquid having entered the casing 2 through the gap S1 between the casing 2 and the open button 4 is drained out of the casing 2 without causing water immersion of the substrate 24 or other components.

### Operations and Effects

Next, operations and effects of the above-mentioned thermal printer 1 are described. According to the thermal printer 1 in this embodiment, the thermal printer 1 includes the casing 2 (housing in claims), the printing unit 5, the paper cover 3 (cover in claims), the open button 4, and the guide shaped portions 6. Each of the guide shaped portions 6 is provided below the gap S1 between the open button 4 and the housing and at a position corresponding to the gap S1 in the horizontal posture, and each of the guide shaped portions 6 extends along the up-and-down direction. With this configuration, the guide shaped portion 6 extending along the up-and-down direction is provided at a position corresponding to the gap S1 that is defined between the open button 4 and the casing 2 and allows entry of the liquid easily. Accordingly, the liquid that adheres to an upper portion of the guide shaped portion 6 can be guided downward along the guide shaped portion 6. Thus, even when the liquid enters the casing 2 through the gap S1 between the open button 4 and the casing 2, an electronic component such as the substrate 24 can be prevented from being splashed with water. Further, the liquid flows downward along the guide shaped portion 6, and thus the liquid having entered the casing 2 can be guided to a target position relatively easily. This can prevent water immersion in an unintended region within the casing 2. Moreover, each of the guide shaped portions 6 is provided directly below the gap S1 between the open button 4 and the casing 2. Accordingly, the liquid having entered the casing 2 through the gap S1 comes into contact with the guide shaped portion 6, and thus the momentum of the liquid is reduced, thereby being capable of more reliably guiding the liquid downward along the guide shaped portion 6. Consequently, the thermal printer 1 capable of effectively preventing water immersion in the casing 2 can be provided.

The guide shaped portions 6 are provided between the casing 2 and the release lever 23 (opposed component in claims) received inside the casing 2. With this configuration, a flow passage of the liquid having entered the casing 2 is narrowed by the casing 2 and the release lever 23, and hence the liquid having entered the casing 2 through the gap S1 easily comes into contact with the guide shaped portions 6. Thus, the liquid comes into contact with the guide shaped portions 6, thereby being capable of reducing the momentum of the liquid and guiding the liquid downward along the guide shaped portions 6. Accordingly, water immersion in the casing 2 can be prevented more effectively.

The guide shaped portions 6 extend downward beyond the release lever 23. With this configuration, the guide shaped portions 6 extend downward beyond the release lever 23, and hence the liquid can be caused to flow along the guide shaped portions 6 even after passing through between the casing 2 and the release lever 23. Thus, the liquid having flowed between the casing 2 and the release lever 23 is prevented from spattering on a terminal portion of the release lever 23 (that is, the lower end portion of the release lever 23), thereby being capable of guiding the liquid, which has entered the casing, to a target position. Accordingly, particularly in a case of a configuration in which electronic components such as the substrate 24 are arranged below the release lever 23, the electronic components or other components can be prevented from being splashed with water, and water immersion in the casing 2 can be prevented effectively.

The substrate 24 is provided below the release lever 23. The substrate 24 is arranged closer to the center of the inside of the casing 2 than the release lever 23 when seen from the up-and-down direction. Each of the guide shaped portions 6 is provided at such a position as to be prevented from overlapping the substrate 24 when seen from the up-and-down direction. With this configuration, the substrate 24 is provided closer to the center of the inside of the casing 2 than the release lever 23, and hence the liquid having flowed between the casing 2 and the release lever 23 can be less liable to be splashed on the substrate 24. Accordingly, particularly the substrate 24 in the casing 2 can be prevented from being immersed in water. The substrate 24 and the guide shaped portions 6 are arranged so as to be prevented from overlapping each other when seen from the up-and-down direction, and hence the liquid having flowed along the guide shaped portions 6 can be prevented from being splashed on the substrate 24. Accordingly, the guide shaped portions 6 can more effectively prevent the substrate 24 from being splashed with water.

Each of the guide shaped portions 6 is provided at a position corresponding to the downward protruding portion 47 (second downward protruding portion 49 in this embodiment) of the open button 4. With this configuration, the liquid having entered the casing 2 through the gap S1 between the casing 2 and the open button 4 enters the casing 2 along the downward protruding portion 47 of the open button 4. Moreover, each of the guide shaped portions 6 is provided at a position corresponding to the downward protruding portion 47 (for example, directly below the downward protruding portion 47), and hence the liquid having flowed along the downward protruding portion 47 easily reaches the guide shaped portions 6. Thus, the liquid can be guided downward along the guide shaped portions 6.

The guide shaped portions 6 are the ribs formed on the inner wall of the casing 2. With this configuration, the guide shaped portions 6 can be formed with a simple configuration. Particularly when the casing 2 and the ribs are formed integrally, the number of components and manufacturing cost can be reduced.

In a bottom surface of the casing 2, the retaining portion 26 that retains the liquid guided by the guide shaped portions 6 is formed. With this configuration, the liquid guided downward along the guide shaped portions 6 accumulates in the retaining portion 26 in the bottom surface of the casing 2. The liquid accumulated in the retaining portion 26 is drained from the drain hole through a flow path in the casing 2 when, for example, the posture of the thermal printer 1 is changed to the carriage posture. Thus, it is not required to additionally provide a drain hole for the horizontal posture, and it is not required to increase a size of the drain hole. Accordingly, the liquid having entered the casing 2 can be drained while preventing complication and increase in size of the configuration. Further, with the retaining portion 26, the liquid guided downward along the guide shaped portions 6 is collected, thereby being capable of preventing the substrate 24 or other components from being splashed with the liquid guided downward. Accordingly, water immersion in the casing 2 can be prevented effectively.

### Second Embodiment

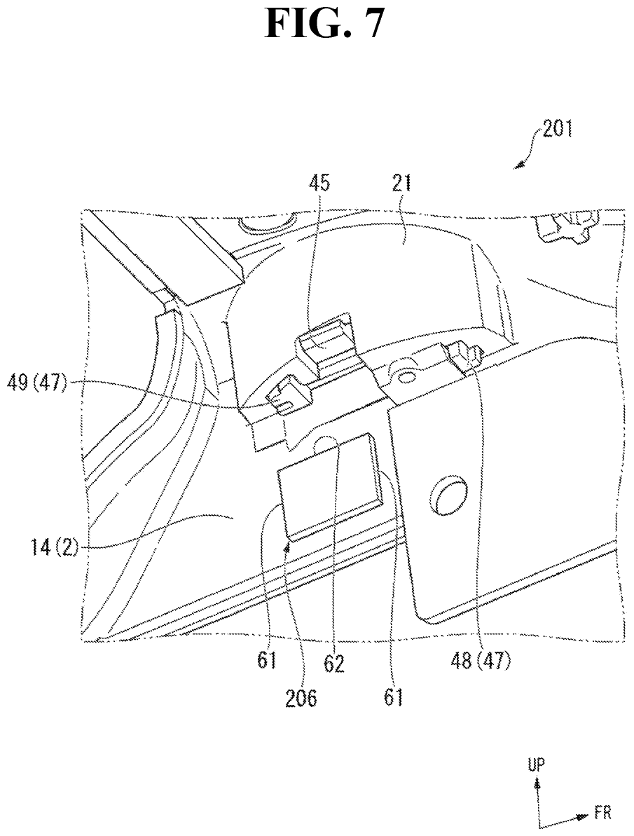

FIG. 7 is a perspective view of an inside of the casing 2 of a thermal printer 201 according to a second embodiment when seen from the lower side. FIG. 7 is a perspective view corresponding to FIG. 6 in the first embodiment. In the second embodiment, a guide shaped portion 206 differs in shape, material, and the like from the guide shaped portion in the first embodiment.

As illustrated in FIG. 7, similarly to the first embodiment, the thermal printer 201 according to the second embodiment includes the guide shaped portion 206 that is provided below the gap S1 (see FIG. 4) between the open button 4 and the casing 2 and at a position corresponding to the gap S1. The guide shaped portion 206 is provided at least directly below the second downward protruding portion 49 of the open button 4. In this embodiment, the guide shaped portion 206 has a rectangular shape when seen from the right-and-left direction. The guide shaped portion 206 is provided so as to protrude from the inner wall of the casing 2 toward the inside of the casing 2. Further, the guide shaped portion 206 is formed of a water absorbing member. That is, the guide shaped portion 206 in this embodiment is formed by, for example, affixing a member (water absorbing member) having a rectangular shape and a water absorbing property to the casing 2. In this case, a pair of side surfaces 61 and 61 of the guide shaped portion 206 having a rectangular shape, which are directed in the front-and-rear direction, are constituents of the guide shaped portion 206 extending along the up-and-down direction. Accordingly, in the second embodiment, it is not always required that the guide shaped portion 206 have a vertically-elongated shape when seen from the right-and-left direction.

According to the thermal printer 201 in the second embodiment, the guide shaped portion 206 absorbs at least part of the liquid, and hence the momentum of the liquid having entered the casing 2 can be reduced more effectively. Further, the liquid flows downward in the guide shaped portion 206 or along an outer surface (for example, the pair of side surfaces 61 and 61) of the guide shaped portion 206, and hence the liquid can be guided downward along the guide shaped portion 206. Further, as compared to the first embodiment in which the guide shaped portion 6 is formed into a rib shape, an area of an upper surface 62 of the guide shaped portion 206 can be increased. Thus, the liquid having entered the casing 2 through the gap S1 between the casing 2 and the open button 4 easily comes into contact with the upper surface 62 of the guide shaped portion 206, and thus the momentum of the liquid can be reduced. Consequently, spattering of the liquid is prevented, and the liquid can be guided downward along the guide shaped portion 206 effectively.

The technical scope of the present invention is not limited to the above-mentioned embodiments, and various modifications may be made without departing from the gist of the present invention. For example, in the embodiments described above, the release lever 23 is described as the opposed component, but the present invention is not limited thereto. A component other than the release lever 23, which is received in the casing 2, may be the opposed component. In this case, the guide shaped portion 6 may be provided between the opposed component and the inner wall of the casing 2.

The open button 4 may include only one downward protruding portion 47. Alternatively, three or more downward protruding portions 47 may be formed. When the open button 4 includes a plurality of downward protruding portions 47, the guide shaped portion 6 may be provided directly below any one of the downward protruding portions 47. The guide shaped portions 6 may be respectively provided directly below a plurality of specific downward protruding portions 47 among the plurality of downward protruding portions 47.

A plurality of guide shaped portions 6 may be provided. When the plurality of guide shaped portions 6 are provided, there are increased areas of surfaces (upper surfaces) of the guide shaped portions 6, with which the liquid having entered the casing 2 through the gap S1 between the casing 2 and the open button 4 comes into contact, with the result that superiority is gained in view of more easily reducing the momentum of the liquid.

Besides the above, the components in the above-mentioned embodiments may be replaced by well-known components as appropriate without departing from the gist of the present invention. Further, the above-mentioned embodiments can be combined with each other as appropriate.

What is claimed is:

1. A thermal printer, comprising:
a housing;
a printing unit, which includes a head unit and a platen unit including a platen roller, and is received in the housing;
a cover configured to be capable of opening and closing the housing;
an open button of the cover; and
a guide shaped portion, which is provided below a gap between the open button and the housing and at a position corresponding to the gap, and extends along an up-and-down direction in a horizontal posture that is a state of the thermal printer placed such that a sheet delivery port defined between the cover and the housing is facing upward.

2. The thermal printer according to claim 1, wherein the guide shaped portion is provided between the housing and an opposed component received inside the housing.

3. The thermal printer according to claim 2, wherein the guide shaped portion extends downward beyond the opposed component.

4. The thermal printer according to claim 2, further comprising a substrate provided below the opposed component,
wherein the substrate is arranged closer to a center of an inside of the housing than the opposed component when seen from the up-and-down direction, and
wherein the guide shaped portion is provided at such a position as to be prevented from overlapping the substrate when seen from the up-and-down direction.

5. The thermal printer according to claim 1,
wherein the open button includes a downward protruding portion that protrudes downward, and
wherein the guide shaped portion is provided at a position corresponding to the downward protruding portion.

6. The thermal printer according to claim 1, wherein the guide shaped portion is a rib formed on an inner wall of the housing.

7. The thermal printer according to claim 1, wherein the guide shaped portion is formed of a water absorbing member.

8. The thermal printer according to claim 1, further comprising a retaining portion, which is formed in a bottom surface of the housing, and is configured to retain liquid guided by the guide shaped portion.
